(19) United States
(12) Patent Application Publication
(10) Pub. No.: US 2025/0365731 A1
(43) Pub. Date: Nov. 27, 2025

(54) METHOD AND APPARATUS FOR SYNCHRONIZATION SIGNAL BLOCK TRANSMISSION IN MOBILE WIRELESS COMMUNICATION SYSTEM

(71) Applicants: Soenghun Kim, Hanam-si (KR); BLACKPIN INC., Seoul (KR)

(72) Inventor: Soenghun Kim, Hanam-si (KR)

(21) Appl. No.: 19/210,449

(22) Filed: May 16, 2025

(30) Foreign Application Priority Data
May 22, 2024 (KR) 10-2024-0066411
May 22, 2024 (KR) 10-2024-0066412

(51) Int. Cl. H04W 72/1273; H04W 72/23

(52) U.S. Cl. CPC H04W 72/1273; H04W 72/23

(57) ABSTRACT

A method and apparatus to support efficient SSB transmission is provided. The method includes receiving by the terminal from the base station one or more additional ssb-periodicityServingCell, receiving by the terminal from the base station a DCI scrambled with a second RNTI, receiving by the terminal from the base station the DCI scrambled with the first RNTI and receiving by the terminal from the base station the PDSCH based on that symbols where SS/PBCH block is transmitted are not available for the PDSCH, wherein the symbols where SS/PBCH block is transmitted are determined based on the specific additional ssb-periodicityServingCell.

### CROSS-REFERENCE TO RELATED APPLICATION

This application claims priority to and the benefit of Korean Patent Application No. 10-2024-0066411 and No. 10-2024-0066412, filed on May 22, 2024, the disclosure of which is incorporated herein by reference in its entirety.

### BACKGROUND

### Technical Field

The present disclosure relates to synchronization signal transmission for network energy efficiency in a mobile communication system.

### Related Art

To meet the increasing demand for wireless data traffic since the commercialization of 4th generation (4G) communication systems, the 5th generation (5G) system is being developed. 5G system introduced millimeter wave (mmW) frequency bands (e.g., 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability.

In the advancement of 5G networks, one significant focus is improving network energy efficiency. A key innovation in this area is Synchronization Signal Block (SSB) transmission.

SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network.

Periodic transmission of SSBs degrades network energy efficiency especially in low load/traffic scenario.

### SUMMARY

A method and apparatus to support efficient SSB transmission is provided. The method includes receiving by the terminal from the base station one or more additional ssb-periodicityServingCell, receiving by the terminal from the base station a DCI scrambled with a second RNTI, receiving by the terminal from the base station the DCI scrambled with the first RNT and receiving by the terminal from the base station the PDSCH based on that symbols where SS/PBCH block is transmitted are not available for the PDSCH, wherein the symbols where SS/PBCH block is transmitted are determined based on the specific additional ssb-periodicityServingCell.

### BRIEF DESCRIPTION OF THE DRAWINGS

FIG. 1 is a diagram illustrating the architecture of a 5G system and a NG-RAN.

FIG. 2 is a diagram illustrating a wireless protocol architecture in a 5G system.

FIG. 3 illustrates the overall operation of the UE and network.

FIG. 4 illustrates RRC connection establishment procedure.

FIG. 5 illustrates UE capability transfer procedure.

FIG. 6 illustrates RRC connection reconfiguration procedure.

FIG. 7 illustrates data transfer procedure in RRC_CONNECTED state.

FIG. 8 illustrates SS/PBCH block.

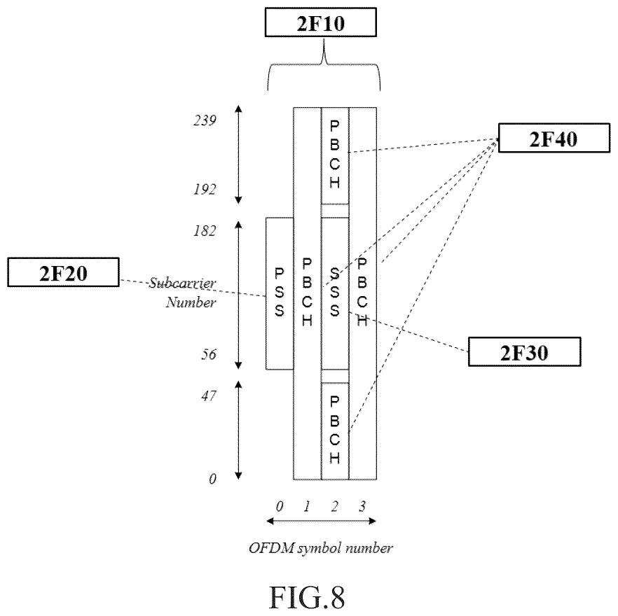

FIG. 9 illustrates the operation of the UE and network.

FIG. 10 is a diagram illustrating measurement operations of the terminal.

FIG. 11 is a block diagram illustrating the internal structure of a UE to which the disclosure is applied.

FIG. 12 is a block diagram illustrating the configuration of a base station according to the disclosure.

### DETAILED DESCRIPTION

SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network, which results in unnecessary network energy consumption. One solution to remedy this problem is dynamically adjusting the periodicity with consideration on demand.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

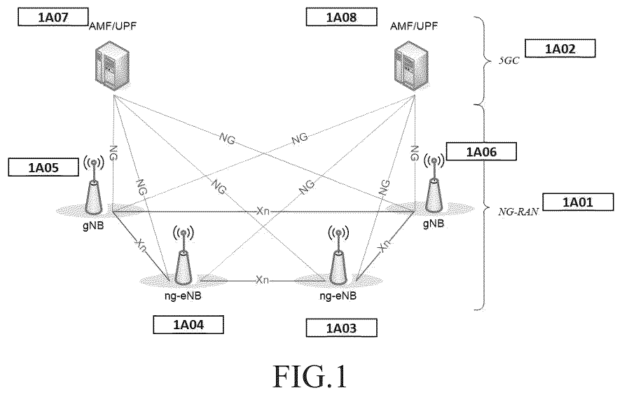

FIG. 1 is a diagram illustrating the architecture of a 5G system and a NG-RAN to which the disclosure may be applied.

5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QOS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

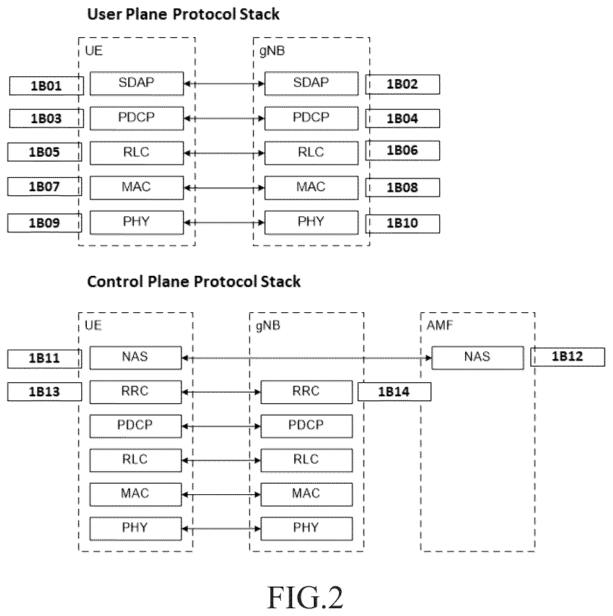

FIG. 2 is a diagram illustrating a wireless protocol architecture in a 5G system to which the disclosure may be applied.

The user plane protocol stack consists of SDAP 1B01 or 1B02, PDCP 1B03 or 1B04, RLC 1B05 or 1B06, MAC 1B07 or 1B08 and PHY 1B09 or 1B10. The control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

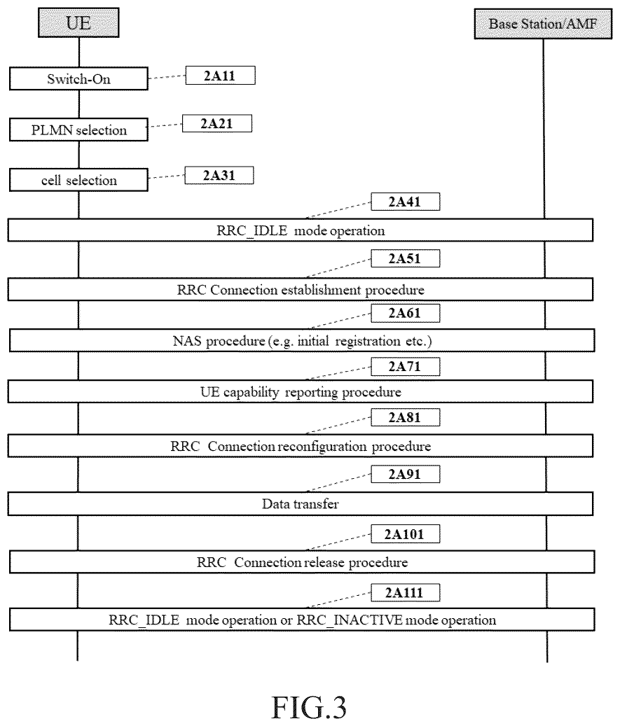

FIG. 3 illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE perform RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

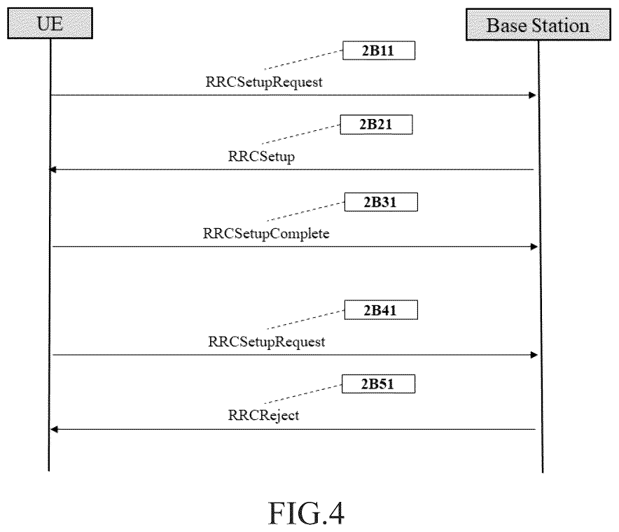

FIG. 4 illustrates RRC connection establishment procedure.

Successful RRC connection establishment procedure comprises:
>1: transmission of RRCSetupRequest by the UE 2B11;
>1: reception of RRCSetup by the UE 2B21;
>1: transmission of RRCSetupComplete by the UE 2B31.

Unsuccessful RRC connection establishment procedure comprises:
>1: transmission of RRCSetupRequest by the UE 2B41;
>1: reception of RRCReject by the UE 2B51;

RRCSetupRequest comprises following fields and IEs:
>1: ue-Identity field contains InitialUE-Identity IE which contains:
>>2: ng-5G-S-TMSI-Part1 field containing a BIT STRING of 39 bit;
>1: establishmentCause field contains EstablishmentCause IE which contains:
>>2 enumerated value indicating either emergency, highPriorityAccess, mt-Access, mo-Signalling, mo-Data, mo-VoiceCall, mo-VideoCall, mo-SMS, mps-PriorityAccess, mcs-PriorityAccess etc

RRCSetup comprises following fields and IEs:
>1: radioBearerConfig field containing a RadioBearerConfig IE;
>1: masterCellGroup field containing a CellGroupConfig IE.

RRCSetupComplete comprises following fields and IEs:
>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identifies the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;

The UE transmits to the base station RRCSetupComplete after performing above actions.

The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentityInfoList;
>1: include the s-NSSAI-List and set the content to the values provided by the upper layers;

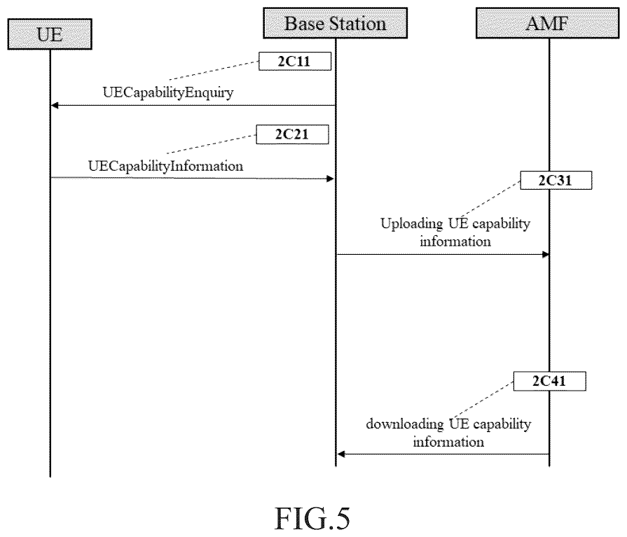

FIG. 5 illustrates UE capability transfer procedure.

For network to configure the UE with appropriate configurations, the network needs to know the capability of the UE. For this end, the UE and the base station perform UE capability transfer procedure.

UE capability transfer procedure consists of exchanging UECapabilityEnquiry 2C11 and UECapabilityInformation 2C21 between the UE and the base station.

In the UECapabiliityEnquiry, the base station indicates which RAT is subject to capability reporting. UE transmits the capability information for the requested RAT in the UECapabilityInformation.

Once UECapabilityInformation is received, the capability information is uploaded to the AMF by the base station 2C31. When UE capability information is needed afterward, AMF provides it to the base station 2C41.

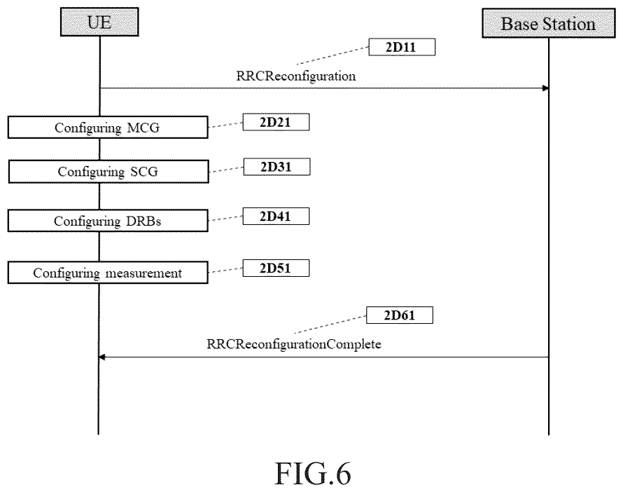

FIG. 6 illustrates RRC connection reconfiguration procedure.

Based on the reported capability and other factors such as required QoS and call admission control etc., the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2D11 and RRCReconfigurationComplete 2D61 between the base station and the UE.

RRCReconfiguration may comprise following fields and IEs:
>1: rrc-TransactionIdentifier field contains a RRC-TransactionIdentifier IE;
>1: radioBearerConfig field contains a RadioBearerConfig IE;
   >>2: radioBearerConfig field comprises configuration information for SRBs and DRBs via which RRC messages and user traffic are transmitted and received;
>1: secondaryCellGroup field contains a CellGroupConfig IE;
   >>2: secondaryCellGroup field comprises configuration information for secondary cell group;
   >>2: A cell group consists of a SpCell and zero or more SCells;
   >>2: Cell group configuration information comprises cell configuration information for SpCell/SCell and configuration information for MAC and configuration information for logical channel etc;
>1: measConfig field contains a MeasConfig IE;
   >>2: measConfig field comprises configuration information for measurements that the UE is required to perform for mobility and other reasons.
>1: masterCellGroup field contains a CellGroupConfig IE;

Upon reception of RRCReconfiguration, UE processes the IEs in the order as below. UE may:
>1: perform the cell group configuration for MCG based on the received masterCellGroup 2D21;
>1: perform the cell group configuration for SCG based on the received secondaryCellGroup 2D31;
>1: perform the radio bearer configuration based on the received radioBearerConfig 2D41;
>1: perform the measurement configuration based on the received measConfig 2D51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

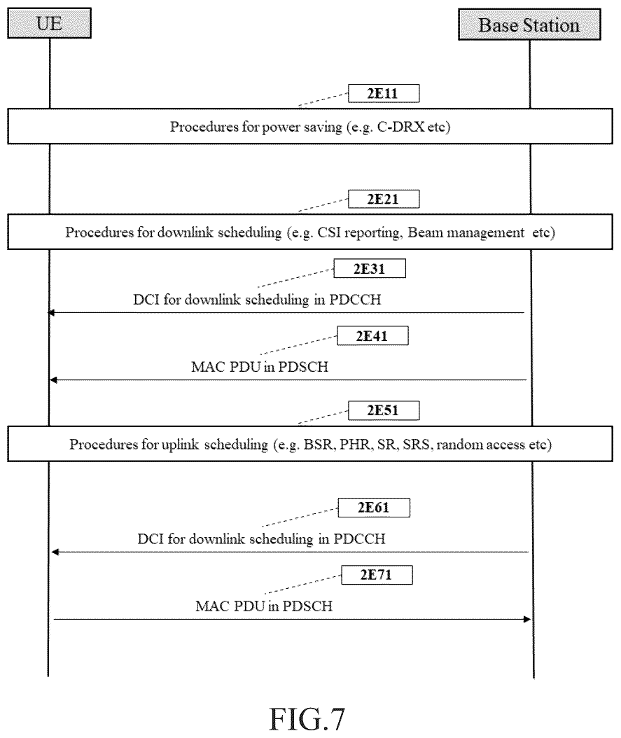

FIG. 7 illustrates data transfer procedure in RRC_CONNECTED state.

The UE and the base station may perform procedures for power saving such as C-DRX 2E11. The configuration information for C-DRX is provided to the UE within cell group configuration in the RRCReconfiguration.

The UE and the base station may perform various procedures for downlink scheduling 2E21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2E31. The base station transmits to the UE PDSCH corresponding to the DCI and containing a MAC PDU 2E41.

The UE and the base station may perform various procedures for uplink scheduling 2E51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2E61. The base station transmits to the UE PDSCH corresponding to the DCI and containing a MAC PDU 2E71.

The Synchronization Signal and PBCH block (SSB) 2F10 consists of primary synchronization signals (PSS) 2F20 and secondary synchronization signals (SSS) 2F30, PSS and SSS occupies 1 symbol and 127 subcarriers. PBCH 2F40 spans across 3 OFDM symbols and 240 subcarriers The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

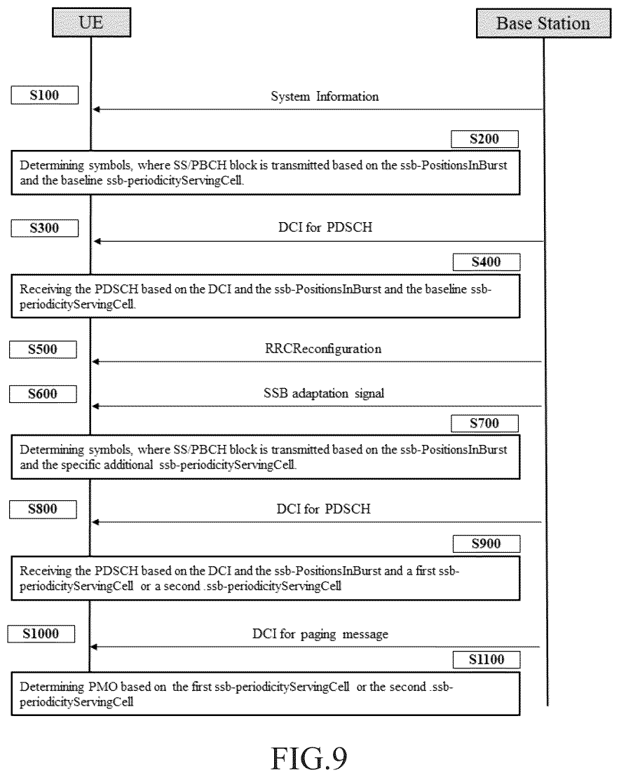

FIG. 9 illustrates operations of UE and base station.

The following are used interchangeably:
>: SSB adaptation signal and SSB adaptation DCI;

At S100, UE receives a system information that contains a ssb-PositionsInBurst and a baseline ssb-periodicityServingCell. Alternatively, UE receives the ssb-PositionsInBurst and the baseline ssb-periodicityServingCell via RRCReconfiguration message.

At S200, UE determines symbols, in a first period, where SS/PBCH block is transmitted based on the ssb-PositionsInBurst and the baseline ssb-periodicityServingCell. The first period is during when SSB is transmitted based on the baseline periodicity.

At S300, UE receives a DCI scrambled with C-RNTI that schedules PDSCH.

At S400, UE receives the PDSCH based on the DCI and the ssb-PositionsInBurst and the baseline ssb-periodicityServingCell. time/frequency resources for the PDSCH are indicated in the DCI. UE excludes specific PRBs and specific symbols from the time/frequency resources for the PDSCH. The specific PRBs and specific symbols are related both to SSB transmission and PDSCH transmission. The specific PRBs in specific symbols are not available for PDSCH. The specific PRBs are PRB where SS/PBCH block transmission occurs. The specific PRBs are predetermined without explicit signaling.

The specific symbols are determined, based on <SS/PBCH transmission/reception> according to the ssb-PositionsInBurst and the baseline ssb-periodicityServingCell.

At S500, UE receives a RRC reconfiguration message that contains:
>: one or more additional ssb-periodicityServingCells;
>: SearchSpace for SSB adaptation signal; and
>: SSB-RNTI (alternatively, SSB-RNTI is predefined in the specification/no need for explicit signal to configure).

SearchSpace for SSB adaptation signal is a common search space.

SSB-RNTI is allocated to a group of UEs.

C-RNTI is allocated to a specific UE.

At S600, UE receives SSB adaptation signal based on the SSB-RNTI and the SearchSpace for SSB adaptation signal.

For SSB adaptation signal received at symbol n, the SSB adaptation signal indicates that a specific additional ssb-periodicityServingCell is activated/applied. SSB is adapted from the current periodicity to a specific additional periodicity from symbol n+m. The signal indicates an integer. Each integer is associated with each ssb-periodicityServingCells.
>>: integer 0 in the DCI indicates baseline additional ssb-periodicityServingCells;
>>: integer 1 in the DCI indicates the first additional ssb-periodicityServingCells in the list; and
>>: integer 2 in the DCI indicates the second additional ssb-periodicityServingCells in the list and so on.

At S700, UE determines symbols, in a second period, where SS/PBCH block is transmitted based on the ssb-PositionsInBurst and the specific additional ssb-periodicityServingCell.

At S800, UE receives a DCI scrambled with C-RNTI that schedules PDSCH.

At S900, UE receives the PDSCH based on the DCI and:
>: the second ssb-periodicityServingCell in case that PDSCH duration starts after a first time point (in case that PDSCH duration is completely contained in the second period); or
>: the first ssb-periodicityServingCell in case that PDSCH duration ends before the first time point (in case that PDSCH duration is completely contained in the first period); or
>: the first ssb-periodicityServingCell before the first time point and the second ssb-periodicityServingCells after the first time point in case that the PDSCH duration starts before the first time point and ends after the first time point (in case that PDSCH duration is partly contained in the first period and partly in the second period).

The first ssb-periodicityServingCell is ssb-periodicityServingCell that has been used before SSB adaptation signal is received.

The second ssb-periodicityServingCell is ssb-periodicityServingCell that is indicated in the SSB adaptation signal.

The first point of time is x symbols after symbol n. x is determined based on SCS of active DL BWP where SS/PBCH block is transmitted (or subCarrierSpacingCommon). x is m if SCS is 15 KHz; x is 2 m is SCS is 30 KHz, m is 4 m if SCS is 60 KHz and so on.

The first period is period before the first point of time.

The second period is period after the first period of time.

At S1000, UE receives a DCI scheduling paging message in a PMO of a PO.

At S1100, PMO is determined based on SSB index. UE determines SSB index based on the first ssb-periodicityServingCell before the first time point and based on the second ssb-periodicityServingCell after the first time point (UE determines SSB index based on the first ssb-periodicityServingCell during the first period and based on the second ssb-periodicityServingCell during the second period).

### PDSCH Resource Mapping

When receiving the PDSCH scheduled with SI-RNTI and the system information indicator in DCI is set to 0, the UE shall assume that no SS/PBCH block, after puncturing if applicable, is transmitted in REs used by the UE for a reception of the PDSCH.

When receiving the PDSCH scheduled with SI-RNTI and the system information indicator in DCI is set to 1, RA-RNTI, MSGB-RNTI, P-RNTI or TC-RNTI, the UE assumes SS/PBCH block transmission according to ssb-PositionsInBurst, and if the PDSCH resource allocation overlaps with PRBs containing SS/PBCH block transmission resources the UE shall assume that the PRBs containing SS/PBCH block transmission resources, after puncturing if applicable, are not available for PDSCH in the OFDM symbols where SS/PBCH block is transmitted.

A UE expects a configuration provided by ssb-PositionsInBurst in ServingCellConfigCommon to be same as a configuration provided by ssb-PositionsInBurst in SIB1.

When receiving PDSCH scheduled by PDCCH with CRC scrambled by C-RNTI, MCS-C-RNTI, CS-RNTI, G-RNTI, G-CS-RNTI, MCCH-RNTI, multicast-MCCH-RNTI or PDSCHs with SPS, the UE assumes SS/PBCH block transmission according to ssb-PositionsInBurst if the PDSCH resource allocation overlaps with PRBs containing SS/PBCH block transmission resources, after puncturing if applicable, and the UE shall assume that the PRBs containing SS/PBCH block transmission resources, after puncturing if applicable, are not available for PDSCH in the OFDM symbols where SS/PBCH block associated with the same PCI is transmitted.

A UE is not expected to handle the case where PDSCH DM-RS REs are overlapping, even partially, with any RE(s) not available for PDSCH.

### SS/PBCH Transmission/Reception

A UE assumes that reception occasions of a physical broadcast channel (PBCH), PSS, and SSS are in consecutive symbols, and form a SS/PBCH block. The UE assumes that SSS, PBCH DM-RS, and PBCH data have same EPRE. The UE may assume that the ratio of PSS EPRE to SSS EPRE in a SS/PBCH block is either 0 dB or 3 dB. If the UE has not been provided dedicated higher layer parameters, the UE may assume that the ratio of PDCCH DMRS EPRE to SSS EPRE is within −8 dB and 8 dB when the UE monitors PDCCHs for a DCI format 1_0 with CRC scrambled by SI-RNTI, P-RNTI, or RA-RNTI, or for a DCI format 2_7, or for a DCI format 4_0.

For a half frame with SS/PBCH blocks, the first symbol indexes for candidate SS/PBCH blocks are determined according to the SCS of SS/PBCH blocks as follows, where index 0 corresponds to the first symbol of the first slot in a half-frame.
>: Case A—15 kHz SCS: the first symbols of the candidate SS/PBCH blocks have indexes of {2,8}+14·n.
   >>: For carrier frequencies smaller than or equal to 3 GHz, n=0,1.
   >>: For carrier frequencies within FR1 larger than 3 GHz, n=0,1,2,3.
>: Case B—30 kHz SCS: the first symbols of the candidate SS/PBCH blocks have indexes {4,8,16,20}+28·n. For carrier frequencies smaller than or equal to 3 GHz, n=0. For carrier frequencies within FR1 larger than 3 GHz, n=0,1.
>: Case C—30 kHz SCS: the first symbols of the candidate SS/PBCH blocks have indexes {2,8}+14·n.
   >>: For paired spectrum operation
      >>>: For carrier frequencies smaller than or equal to 3 GHz, n=0,1. For carrier frequencies within FR1 larger than 3 GHz, n=0,1,2,3.
   >>: For unpaired spectrum operation
      >>>: For carrier frequencies smaller than 1.88 GHz, n=0,1. For carrier frequencies within FR1 equal to or larger than 1.88 GHz, n=0,1,2,3.
>: Case D—120 kHz SCS: the first symbols of the candidate SS/PBCH blocks have indexes {4,8,16,20}+28·n. For carrier frequencies within FR2 and FR2-NTN, n=0,1,2,3,5,6,7,8,10,11,12,13,15,16,17,18.
>: Case E—240 kHz SCS: the first symbols of the candidate SS/PBCH blocks have indexes {8,12,16,20,32,36,40,44}+56·n. For carrier frequencies within FR2-1 and FR2-NTN, n=0,1,2,3,5,6,7,8.
>: Case F—480 kHz SCS: the first symbols of the candidate SS/PBCH blocks have indexes {2,9}+14·n. For carrier frequencies within FR2-2, n=0,1,2,3,4,5,6,7,8,9,10,11,12,13,14,15,16,17,18,19,20,21,22,23,24,25,26,27,28,29,30,31.
>: Case G—960 kHz SCS: the first symbols of the candidate SS/PBCH blocks have indexes {2,9}+14·n. For carrier frequencies within FR2-2, n=0,1,2,3,4,5,6,7,8,9,10,11,12,13,14,15,16,17,18,19,20,21,22,23,24,25,26,27,28,29,30,31.

A UE can be provided per serving cell by ssb-periodicityServingCell a base line periodicity of the half frames for reception of the SS/PBCH blocks for the serving cell. If the field is absent, UE assumes the baseline periodicity is a predefined value.

A UE can be provided per serving cell by AdditionalSsb-periodicityToAddModList one or more additional periodicities of the half frames for reception of the SS/PBCH blocks for the serving cell. If the field is absent, UE assumes additional periodicities are not configured for the serving cell.

The baseline periodicity is enabled via RRC message. The additional periodicity is enabled via a specific DCI.

The IE ServingCellConfigCommon is used to configure cell specific parameters of a UE's serving cell. The IE contains parameters which a UE would typically acquire from SSB, MIB or SIBs when accessing the cell from IDLE. With this IE, the network provides this information in dedicated signalling when configuring a UE with a SCells or with an additional cell group (SCG). It also provides it for SpCells (MCG and SCG) upon reconfiguration with sync.

```
  -- ASN1START
  -- TAG-SERVINGCELLCONFIGCOMMON-START
```

| | |
|---|---|
| ServingCellConfigCommon ::= | SEQUENCE { |
| physCellId | PhysCellId |

OPTIONAL, -- Cond HOAndServCellAdd,

| | |
|---|---|
| downlinkConfigCommon | DownlinkConfigCommon |

OPTIONAL, -- Cond HOAndServCellAdd

| | |
|---|---|
| uplinkConfigCommon | UplinkConfigCommon |

OPTIONAL, -- Need M

| | |
|---|---|
| supplementaryUplinkConfig | UplinkConfigCommon |

OPTIONAL, -- Need S

| | |
|---|---|
| n-TimingAdvanceOffset | ENUMERATED { n0, n25600, |
| n39936 } | OPTIONAL, -- Need S |
| ssb-PositionsInBurst | CHOICE { |
| shortBitmap | BIT STRING (SIZE (4)), |
| mediumBitmap | BIT STRING (SIZE (8)), |
| longBitmap | BIT STRING (SIZE (64)) |

}
OPTIONAL, -- Cond AbsFreqSSB

| | |
|---|---|
| ssb-periodicityServingCell | ENUMERATED { ms5, ms10, ms20, |
| ms40, ms80, ms160, spare2, spare1 } | OPTIONAL, -- Need S |
| dmrs-TypeA-Position | ENUMERATED {pos2, pos3}, |
| lte-CRS-ToMatchAround | SetupRelease |
| { RateMatchPatternLTE-CRS } | OPTIONAL, -- Need M |
| rateMatchPatternToAddModList | SEQUENCE (SIZE |
| (1..maxNrofRateMatchPatterns)) OF RateMatchPattern | OPTIONAL, -- Need N |
| rateMatchPatternToReleaseList | SEQUENCE (SIZE |
| (1..maxNrofRateMatchPatterns)) OF RateMatchPatternId | OPTIONAL, -- Need N |
| ssbSubcarrierSpacing | SubcarrierSpacing |

OPTIONAL, -- Cond HOAndServCellWithSSB

| | |
|---|---|
| tdd-UL-DL-ConfigurationCommon | TDD-UL-DL-ConfigCommon |

OPTIONAL, -- Cond TDD

| | |
|---|---|
| ss-PBCH-BlockPower | INTEGER (−60..50), |

```
    ...,
    [[
```

| | |
|---|---|
| channelAccessMode-r16 | CHOICE { |
| dynamic | NULL, |

```
      semiStatic
SemiStaticChannelAccessConfig-r16
    }
OPTIONAL, -- Cond SharedSpectrum
```

| | |
|---|---|
| discoveryBurstWindowLength-r16 | ENUMERATED {ms0dot5, |
| ms1, ms2, ms3, ms4, ms5} | OPTIONAL, -- Need R |
| ssb-PositionQCL-r16 | SSB-PositionQCL-Relation- |
| r16 | OPTIONAL, -- Cond SharedSpectrum |
| highSpeedConfig-r16 | HighSpeedConfig-r16 |

```
OPTIONAL -- Need R
    ]],
    [[
```

| | |
|---|---|
| highSpeedConfig-v1700 | HighSpeedConfig-v1700 |

OPTIONAL, -- Need R

| | |
|---|---|
| channelAccessMode2-r17 | ENUMERATED {enabled} |

OPTIONAL, -- Cond SharedSpectrum2

| | |
|---|---|
| discoveryBurstWindowLength-r17 | ENUMERATED {ms0dot125, |
| ms0dot25, ms0dot5, ms0dot75, ms1, ms1dot25} | OPTIONAL, -- Need R |
| ssb-PositionQCL-r17 | SSB-PositionQCL-Relation-r17 |

OPTIONAL, -- Cond SharedSpectrum2

| | |
|---|---|
| highSpeedConfigFR2-r17 | HighSpeedConfigFR2-r17 |

OPTIONAL, -- Need R

| | |
|---|---|
| uplinkConfigCommon-v1700 | UplinkConfigCommon-v1700 |

OPTIONAL, -- Need R

| | |
|---|---|
| ntn-Config-r17 | NTN-Config-r17 |

```
OPTIONAL -- Need R
    ]],
    [[
```

| | |
|---|---|
| featurePriorities-r17 | SEQUENCE { |
| redCapPriority-r17 | FeaturePriority-r17 |

OPTIONAL, -- Need R

| | |
|---|---|
| slicingPriority-r17 | FeaturePriority-r17 |

OPTIONAL, -- Need R

| | |
|---|---|
| msg3-Repetitions-Priority-r17 | FeaturePriority-r17 |

OPTIONAL, -- Need R

| | |
|---|---|
| sdt-Priority-r17 | FeaturePriority-r17 |

```
OPTIONAL -- Need R
    }
OPTIONAL -- Need R
    ]],
    [[
```

| | |
|---|---|
| ra-ChannelAccess-r17 | ENUMERATED {enabled} |

```
OPTIONAL -- Cond SharedSpectrum2
    ]],
    [[
```

| | |
|---|---|
| featurePriorities-v1800 | SEQUENCE { |
| msg1-Repetitions-Priority-r18 | FeaturePriority-r17 |

OPTIONAL, -- Need R

| | |
|---|---|
| eRedCapPriority-r18 | FeaturePriority-r17 |

OPTIONAL -- Need R
}
OPTIONAL, -- Need R

| | |
|---|---|
| atg-Config-r18 | ATG-Config-r18 |

OPTIONAL -- Need R
]]

| | |
|---|---|
| AdditionalSsb-periodicityToAddModList | SEQUENCE (SIZE |

(1..maxNrofadditionalSsbPeriodicity)) OF SSB-periodicityServingCell
}

| | |
|---|---|
| SSB-periodicityServingCell ::= | ENUMERATED { ms5, ms10, ms20, ms40 } |

```
  -- TAG-SERVINGCELLCONFIGCOMMON-STOP
  -- ASN1STOP
```

DownlinkConfigCommon: The common downlink configuration of the serving cell, including the frequency information configuration and the initial downlink BWP common configuration. The parameters provided herein should match the parameters configured by MIB and SIB1 (if provided) of the serving cell, with the exception of controlResourceSetZero and searchSpaceZero which can be configured in ServingCellConfigCommon even if MIB indicates that they are absent.

LongBitmap: Bitmap when maximum number of SS/PBCH blocks per half frame equals to 64.

MediumBitmap: Bitmap when maximum number of SS/PBCH blocks per half frame equals to 8.

n-TimingAdvanceOffset: The N_TA-Offset to be applied for all uplink transmissions on this serving cell if n-TimingAdvanceOffset is not configured.

shortBitmap

Bitmap when maximum number of SS/PBCH blocks per half frame equals to 4.

ss-PBCH-BlockPower: Average EPRE of the resources elements that carry secondary synchronization signals in dBm that the NW used for SSB transmission.

ssb-periodicityServingCell: The SSB periodicity in ms for the rate matching purpose. If the field is absent, the UE applies the value ms5.

ssb-PositionQCL: Indicates the QCL relation between SSB positions for this serving cell.

ssb-PositionsInBurst: For operation in licensed spectrum, indicates the time domain positions of the transmitted SS-blocks in a half frame with SS/PBCH blocks. The first/leftmost bit corresponds to SS/PBCH block index 0, the second bit corresponds to SS/PBCH block index 1, and so on. Value 0 in the bitmap indicates that the corresponding SS/PBCH block is not transmitted while value 1 indicates that the corresponding SS/PBCH block is transmitted. The network configures the same pattern in this field as in the corresponding field in ServingCellConfigCommonSIB.

SsbSubcarrierSpacing: Subcarrier spacing of SSB.

tdd-UL-DL-ConfigurationCommon: A cell-specific TDD UL/DL configuration

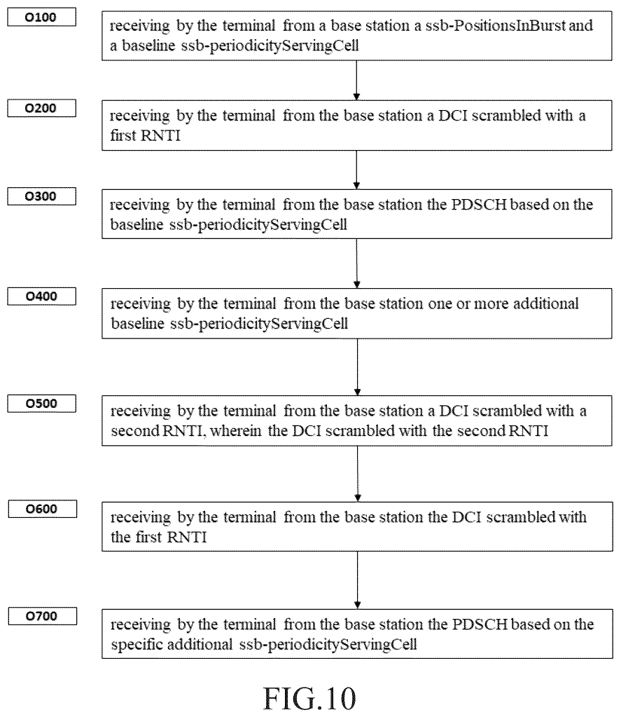

FIG. 10 is a diagram illustrating UE operation.

At O100, the UE receives from a base station a ssb-PositionsInBurst and a baseline ssb-periodicityServingCell.

At O200, the UE receives from the base station a DCI scrambled with a first RNTI, wherein the DCI schedules a PDSCH.

At O300, the UE receives from the base station a PDSCH based on that symbols where SS/PBCH block is transmitted are not available for the PDSCH, wherein the symbols where SS/PBCH block is transmitted are determined based on the baseline ssb-periodicityServingCell.

At O400, the UE receives from the base station one or more additional baseline ssb-periodicityServingCell.

At O500, the UE receives from the base station a DCI scrambled with a second RNTI, wherein the DCI comprises an indication associated with a specific additional ssb-periodicityServingCell.

At O600, the UE receives from the base station a DCI scrambled with the first RNTI, wherein the DCI schedules the PDSCH.

At O700, the UE receives from the base station the PDSCH based on that symbols where SS/PBCH block is transmitted are not available for the PDSCH, wherein the symbols where SS/PBCH block is transmitted are determined based on the specific additional ssb-periodicityServingCell.

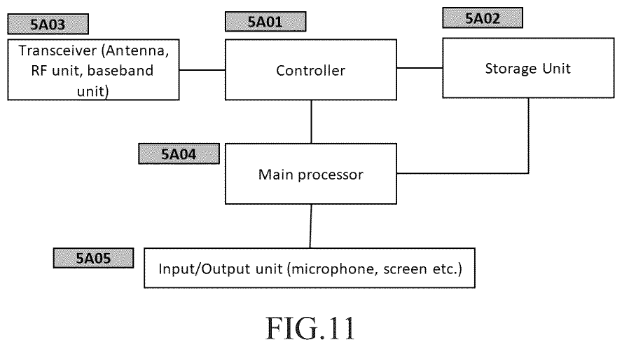

FIG. 11 is a block diagram illustrating the internal structure of a Terminal to which the disclosure is applied.

Referring to the diagram, the terminal includes a controller (5A01), a storage unit (5A02), a transceiver (5A03), a main processor (5A04) and I/O unit (5A05).

The controller (5A01) controls the overall operations of the terminal in terms of mobile communication. For example, the controller (5A01) receives/transmits signals through the transceiver (5A03). In addition, the controller (5A01) records and reads data in the storage unit (5A02). To this end, the controller (5A01) includes at least one processor. For example, the controller (5A01) may include a communication processor (CP) that performs control for communication and an application processor (AP) that controls the upper layer, such as an application program. The controller controls storage unit and transceiver such that UE operations illustrated in this disclosure are performed.

The storage unit (5A02) stores data for operation of the terminal, such as a basic program, an application program, and configuration information. The storage unit (5A02) provides stored data at a request of the controller (5A01).

The transceiver (5A03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (5A04) controls the overall operations other than mobile operation. The main processor (5A04) process user input received from I/O unit (5A05), stores data in the storage unit (5A02), controls the controller (5A01) for required mobile communication operations and forward user data to I/O unit (5A05).

I/O unit (5A05) consists of equipment for inputting user data and for outputting user data such as a microphone and a screen. I/O unit (5A05) performs inputting and outputting user data based on the main processor's instruction.

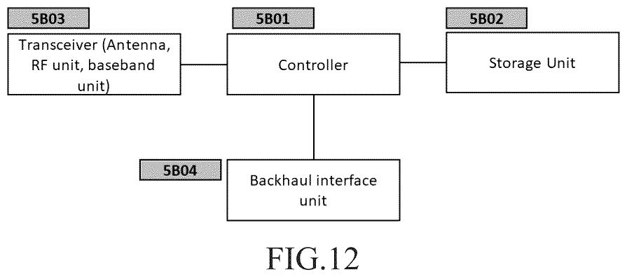

FIG. 12 is a block diagram illustrating the configuration of a base station according to the disclosure.

As illustrated in the diagram, the base station includes a controller (5B01), a storage unit (5B02), a transceiver (5B03) and a backhaul interface unit (5B04).

The controller (5B01) controls the overall operations of the main base station. For example, the controller (5B01) receives/transmits signals through the transceiver (5B03), or through the backhaul interface unit (5B04). In addition, the controller (5B01) records and reads data in the storage unit (5B02). To this end, the controller (5B01) may include at least one processor. The controller controls transceiver, storage unit and backhaul interface such that base station operation illustrated in FIG. 3 are performed.

The storage unit (5B02) stores data for operation of the main base station, such as a basic program, an application program, and configuration information. Particularly, the storage unit (5B02) may store information regarding a bearer allocated to an accessed UE, a measurement result reported from the accessed UE, and the like. In addition, the storage unit (5B02) may store information serving as a criterion to determine whether to provide the terminal with multi-connection or to discontinue the same. In addition, the storage unit (5B02) provides stored data at a request of the controller (5B01).

The transceiver (5B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (5B04) provides an interface for communicating with other nodes inside the network. The backhaul interface unit (5B04) converts a bit string transmitted from the base station to another node, for example, another base station or a core network, into a physical signal, and converts a physical signal received from the other node into a bit string.

Below lists acronym used in the present disclosure.

| | | | |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility Management Function | | |
| RA-RNTI | Random Access RNTI | | |
| ARQ | Automatic Repeat Request | RAT | Radio Access Technology |
| AS | Access Stratum | RB | Radio Bearer |
| ASN.1 | Abstract Syntax Notation One | RLC | Radio Link Control |
| BSR | Buffer Status Report | RNA | RAN-based Notification Area |
| BWP | Bandwidth Part | RNAU | RAN-based Notification Area Update |
| CA | Carrier Aggregation | RNTI | Radio Network Temporary Identifier |
| CAG | Closed Access Group | RRC | Radio Resource Control |
| CG | Cell Group | RRM | Radio Resource Management |
| C-RNTI | Cell RNTI | RSRP | Reference Signal Received Power |
| CSI | Channel State Information | RSRQ | Reference Signal Received Quality |
| DCI | Downlink Control Information | RSSI | Received Signal Strength Indicator |
| DRB | (user) Data Radio Bearer | SCell | Secondary Cell |
| DTX | Discontinuous Reception | SCS | Subcarrier Spacing |
| HARQ | Hybrid Automatic Repeat Request | | |
| SDAP | Service Data Adaptation Protocol | | |
| IE | Information element | SDU | Service Data Unit |
| LCG | Logical Channel Group | SFN | System Frame Number |
| MAC | Medium Access Control | S-GW | Serving Gateway |
| MIB | Master Information Block | SI | System Information |
| NAS | Non-Access Stratum | SIB | System Information Block |
| NG-RAN | NG Radio Access Network | SpCell | Special Cell |
| NR | NR Radio Access | SRB | Signalling Radio Bearer |
| PBR | Prioritised Bit Rate | SRS | Sounding Reference Signal |
| PCell | Primary Cell | SS | Search Space |
| PCI | Physical Cell Identifier | SSB | SS/PBCH block |
| PDCCH | Physical Downlink Control Channel | | |
| SSS | Secondary Synchronisation Signal | | |
| PDCP | Packet Data Convergence Protocol | SUL | Supplementary Uplink |
| PDSCH | Physical Downlink Shared Channel | | |
| TM | Transparent Mode | | |
| PDU | Protocol Data Unit | UCI | Uplink Control Information |
| PHR | Power Headroom Report | UE | User Equipment |
| PLMN | Public Land Mobile Network | UM | Unacknowledged Mode |
| PRACH | Physical Random Access Channel | | |
| CRP | Cell Reselection Priority | | |
| PRB | Physical Resource Block | PSS | Primary Synchronisation Signal |
| PUCCH | Physical Uplink Control Channel | | |
| PUSCH | Physical Uplink Shared Channel | | |

What is claimed is:

1. A method performed by a terminal, the method comprising:
receiving by the terminal from a base station a ssb-PositionsInBurst and a baseline ssb-periodicityServingCell;
receiving by the terminal from the base station a first Downlink Control Information (DCI) scrambled with a first Radio Network Temporary Identifier (RNTI), wherein the first DCI scrambled with the first RNTI schedules a first Physical Downlink Shared Channel (PDSCH);
receiving by the terminal from the base station the first PDSCH based on that first symbols where Synchronization Signal/Physical Broadcast Channel (SS/PBCH) block is transmitted are not available for the first PDSCH, wherein the first symbols where SS/PBCH block is transmitted are determined based on the baseline ssb-periodicityServingCell;
receiving by the terminal from the base station one or more additional ssb-periodicityServingCell;
receiving by the terminal from the base station a second DCI scrambled with a second RNTI, wherein the second DCI scrambled with the second RNTI comprises an indication associated with a specific additional ssb-periodicityServingCell;
receiving by the terminal from the base station a third DCI scrambled with the first RNTI, wherein the third DCI scrambled with the first RNTI schedules a second PDSCH; and
receiving by the terminal from the base station the second PDSCH based on that second symbols where SS/PBCH block is transmitted are not available for the second PDSCH, wherein the second symbols where SS/PBCH block is transmitted are determined based on the specific additional ssb-periodicityServingCell.

2. A terminal in a wireless communication system, the terminal comprising:
a transceiver configured to transmit and receive a signal; and
a controller configured to control the transceiver to:
receive from a base station a ssb-PositionsInBurst and a baseline ssb-periodicityServingCell,
receive from the base station a first Downlink Control Information (DCI) scrambled with a first Radio Network Temporary Identifier (RNTI), wherein the first DCI scrambled with the first RNTI schedules a first Physical Downlink Shared Channel (PDSCH),
receive from the base station the first PDSCH based on that first symbols where Synchronization Signal/Physical Broadcast Channel (SS/PBCH) block is transmitted are not available for the first PDSCH, wherein the first symbols where SS/PBCH block is transmitted are determined based on the baseline ssb-periodicityServingCell,
receive from the base station one or more additional ssb-periodicityServingCell;
receive from the base station a second DCI scrambled with a second RNTI, wherein the second DCI scrambled with the second RNTI comprises an indication associated with a specific additional ssb-periodicityServingCell,
receive from the base station a third DCI scrambled with the first RNTI, wherein the third DCI scrambled with the first RNTI schedules a second PDSCH, and
receive from the base station the second PDSCH based on that second symbols where SS/PBCH block is transmitted are not available for the second PDSCH, wherein the second symbols where SS/PBCH block is transmitted are determined based on the specific additional ssb-periodicityServingCell.
